(19) United States
(12) Patent Application Publication
(10) Pub. No.: US 2013/0054093 A1
(43) Pub. Date: Feb. 28, 2013

(54) MOTOR VEHICLE

(71) Applicants: Franz Fürst, Buxheim (DE); Markus Larice, Karlskron (DE); Tobias Dirndorfer, Munchen (DE)

(72) Inventors: Franz Fürst, Buxheim (DE); Markus Larice, Karlskron (DE); Tobias Dirndorfer, Munchen (DE)

(73) Assignee: Audi AG, Ingolstadt (DE)

(21) Appl. No.: 13/402,361

(22) Filed: Feb. 22, 2012

(30) Foreign Application Priority Data
Feb. 23, 2011 (DE) 102011012081.5

(51) Int. Cl. B60R 22/48; B60R 21/16

(52) U.S. Cl. 701/45

(57) ABSTRACT

A motor vehicle includes a restraint system controlled by a control device, a storage device storing control information for controlling the restraint system, and a computing device. The computing device determines before a collision of the vehicle with a collision object first collision information relating to an impending collision, and determines during an actual collision of the vehicle second collision information relating to the actual collision. The motor vehicle further includes a comparison device producing a comparison result by comparing the first collision information with the second collision information. The control information stored in the storage device is selected when the comparison result indicates that the first collision information is validated in relation to the second collision information, and standard control information is selected in the absence of validation. The restraint system is then controlled with the stored control information or the standard control information, respectively.

### CROSS-REFERENCES TO RELATED APPLICATIONS

This application claims the priority of German Patent Application, Serial No. 10 2011 012 081.5, filed Feb. 23, 2011, pursuant to 35 U.S.C. 119(a)-(d), the content of which is incorporated herein by reference in its entirety as if fully set forth herein.

### BACKGROUND OF THE INVENTION

The present invention relates to a motor vehicle, which includes at least one restraint system controllable by a control device, at least one computing device configured to determine an output at least one first collision information relating to an impending collision of the vehicle with a collision object before a collision of the vehicle with a collision object and to determine and output second collision information relating to the actual collision of the vehicle with the collision object during the collision of the vehicle with the collision object, and a comparison device configured to compare the first collision information and the second collision information and to output a comparison result.

The following discussion of related art is provided to assist the reader in understanding the advantages of the invention, and is not to be construed as an admission that this related art is prior art to this invention.

Modern motor vehicles are known to have different types of restraint systems which protect the vehicle occupants from injuries in a collision of the vehicle with a moving or stationary collision object, for example with another vehicle or a structure. For this purpose, the respective vehicle typically includes standard control information for the corresponding restraint systems according to which the restraint systems are controlled in a collision measured by a collision detection device on the vehicle. The standard control information or the design or actuation of modern restraint systems, for example belt tensioners and/or air bags, is in effect based on the assumption of severe collisions.

Conversely, U.S. Pat. No. 6,169,945 B1 proposes a method for controlling occupant safety systems depending on requirements. Before the collision of the vehicle with a collision object, an expected vehicle acceleration curve is determined by a pre-crash sensor system from a number of acceleration curves stored in the database and compared during the collision with an actual vehicle acceleration curve measured during the collision, wherefrom a specific trigger point of an occupant safety device is selected. If the expected vehicle acceleration curve is not in agreement with the actual measured vehicle acceleration curve, then the expected vehicle acceleration curve is corrected and the trigger point of the occupant safety device is adapted commensurate with the corrected expected vehicle acceleration curve.

Accordingly, the teaching of U.S. Pat. No. 6,169,945 B1 discloses a retrospective approach, because the time and method for controlling various occupant safety devices is defined only during the collision, optionally with multiple corrections. This method must be viewed as being complicated, time-consuming and not satisfactory in view of the short duration of a collision.

It would therefore be desirable and advantageous to obviate prior art shortcomings and to provide an improved motor vehicle, in particular with respect to generating and applying situation-specific control information of at least one restraint system.

### SUMMARY OF THE INVENTION

According to one aspect of the present invention, a motor vehicle includes at least one restraint system, at least one control device controlling the restraint system, a storage device in communication with the control device and storing control information for controlling the restraint system, with the control information being individually defined for different collision processes, and at least one computing device. The computing device is configured to determine and output, before a collision of the vehicle with a collision object, at least one first collision information relating to an impending collision of the vehicle with the collision object, and to determine and output, during an actual collision of the vehicle with the collision object, second collision information relating to the actual collision of the vehicle with the collision object. The motor vehicle further includes a comparison device configured to compare the first collision information with the second collision information and to output a comparison result. The control device is configured to select at least one control information stored in the storage device, when the comparison result indicates that the at least one first collision information is validated in relation to the second collision information, and to control the at least one restraint system commensurate with the selected at least one control information, and to select a standard control information of the at least one restraint system, when the comparison result indicates that the at least one first collision information is not validated in relation to the second collision information, and to control the at least one restraint system commensurate with the standard control information.

With the present invention, the at least one restraint system may be controlled in a collision of the vehicle with at least one collision object commensurate with the particular situation, i.e. the extent and the severity of the respective collision. The comparison device produces a comparison result between the first collision information and the second collision information, which indicates how the actual collision was represented or predicted by the first collision information. Two situations can hereby be contemplated.

In the first situation, the comparison result may show a high degree of agreement between the first collision information and the second collision information, i.e. the actual collision curve represented by the second collision information was adequately and accurately described or predicted by the first collision information. In this situation, the first collision information is validated or confirmed by the second collision information, whereafter the control device of the at least one restraint system selects in a storage device from control information that is individually defined for a plurality of different collision situations the particular control information adapted to the actual collision for controlling the at least one restraint system and uses the particular control information to control the at least one restraint system.

In the second situation, the comparison result may show a lesser degree of agreement or in an extreme case no agreement between the first collision information and the second collision information, i.e. the actual collision represented by the second collision information was not sufficiently or accurately described or predicted, or in extreme cases not described or predicted at all by the first collision information. In this situation, the first collision information is not validated or confirmed by the second collision information, whereafter the control device of the at least one restraint system does not obtain from the storage device a control definition that is individually defined for different collision processes, but instead relies on a standard control information of the at least one restraint system and uses the standard control information to control the at least one restraint system. The standard control information is typically designed for a particularly severe collision.

Because the comparison result between the first collision information and the second collision information can be easily determined and evaluated, the strategy pursued for controlling the at least one restraint system in the actual collision can be determined within a short time. In the aforementioned first situation, control information that is individually defined and adapted to the actual collision process may be used, which is based, for example, on models of different collision processes. In the aforementioned second situation, standard control information is used. Advantageously, complicated and time-consuming computational processes or an adaptation of predetermined control information to the actual collision course can be eliminated with the invention.

The level of agreement required between the first collision information and the second collision information, before the first collision information can be validated by the second collision information, should principally be determined in the factory, and may be different for different vehicles, so that different limit values or limit ranges for a legitimate validation may be predetermined depending particularly on vehicle-specific parameters and/or driving-dynamics parameters.

According to an advantageous feature of the present invention, the first collision information may include, for example, the expected vehicle deceleration in an impending collision of the vehicle with a collision object and information indicating a measure for the expected degree of the deformation of the vehicle in the impending collision. Advantageously, the first collision information may include all information relevant for the impending collision of the vehicle with a collision object, which will be described in more detail later on. This may be a type of corridor for the expected collision course, meaning a region-by-region estimate of specific parameters for the expected collision course.

According to an advantageous feature of the present invention, the second collision information may include, for example, the actual driving deceleration during the collision of the vehicle with the collision object and deformation information representing a measure for the actual degree of the deformation of the vehicle during the collision. Accordingly, the second collision information is directed to basically all relevant information relating to the actual collision and may include, for example, acceleration values, deformation values, etc. for both the own vehicle and the collision object, which can be determined from the physical and/or mechanical and/or geometric parameters of the vehicle, the collision object and the collision course, such as masses, stiffness, speeds, geometric dimensions, in particular the overlap region between the vehicle and collision object during the collision, which is particularly caused by the type of the collision and is different in a frontal collision than in a side collision.

According to an advantageous feature of the present invention, the computing device may also determine more than a first collision information, meaning in a specific case of an impending collision more than a possible collision process or more than a realistic collision course, which may particularly be the case when the type of the collision object cannot be determined with sufficient accuracy, so that a differentiation between a stationary vehicle and a building is impossible ahead of time. A number of comparison results corresponding to the quantity of the first collision information may be determined and outputted, i.e. each first collision information is separately compared with the second collision information in a collision and a corresponding comparison result is outputted. Additionally, it will be understood that the more plausible first collision information, i.e. the comparison resulting in the best agreement between the first collision information and the second collision information, is used as basis for the further course of action, i.e. for selecting control information commensurate with the situation. If all comparison results indicate that none of the first collision information can be validated by the second collision information, then the standard control information is used in a collision. Of course, the quantity of possible first collision information may be limited, so that the computing device may determine and/or output at most three first collision information items.

According to another advantageous feature of the present invention, the control device of the at least one restraint system may be configured to pre-select control information from the storage device based on the first collision information. The time before activation of the at least one restraint system may be further reduced by pre-selecting control information that is individually adapted to an impending collision, if the comparison result indicates that the first collision information is validated by the second collision information. In this case, control information adapted to the actual collision course need not be selected, and the control information preselected when the first collision information was determined may be used instead.

Advantageously, the control device of the at least one restraint system may also be configured to again select an alternative control information from the storage device based on the comparison result. Accordingly, when the first collision information is validated by the comparison result, but another control information appears better adapted to the situation in view of the actual collision course, the preselection may be canceled and the corresponding alternative control information may be selected and applied.

Conversely, if none of the first control information is validated by the comparison result, then the preselection of the control information may be canceled or the previously selected control information may be discarded and the standard control information may be used instead.

According to another advantageous feature of the present invention, when the at least one computing device is unable to provide first collision information, the control device may be configured to control in a collision of the vehicle with a collision object the at least one restraint system according to the standard control information. Accordingly, in situations where, for example, due to a defect in the computing device or a deficiency in the computing device, the first collision information required for determining the first collision information cannot be determined and outputted on all or can be determined and outputted only with errors, the standard control information can usually be used which provides generally comprehensive protection to the vehicle occupants which, however, may not situation-specific.

As briefly described above, a number of parameters may be taken into account when determining the first collision information, wherein the number of the considered parameters is generally an indication for the quality of the first collision information. The at least one computing device may advantageously be configured to take into account at least one vehicle-specific and/or collision-object-specific parameter when determining the first collision information. As mentioned with reference to the second collision information, in particular physical and/or mechanical and/or geometric parameters of the own vehicle, of the collision object as well as of the collision process are important.

According to an advantageous feature of the present invention, vehicle-specific parameters and/or collision-object-specific parameters may be, for example, the mass of the vehicle and/or the stiffness of the vehicle and/or the speed of the vehicle and/or the mass of the collision object and/or the stiffness of the collision object and/or the speed of the collision object and/or the relative speed between the vehicle and the collision object and/or the distance between the vehicle and the collision object and/or deceleration values of the vehicle and/or of the collision object. Physical as well as, in particular, mechanical parameters of the collision object may be determined by way of an object identification, which can be performed with a suitable sensor system in conjunction with a storage device containing a number of different collision objects. For example, a specific vehicle type may be identified and physical and/or mechanical and/or geometric characteristic values associated with the vehicle type may be used. The same applies also to static collision objects, such as buildings, whereby the at least one computing device may optionally rely on data from a navigation device, so that information about buildings existing in a certain environment around the vehicle can be obtained depending on the actual position of the vehicle. The aforementioned list is by no means comprehensive.

According to yet another advantageous feature of the present invention, the at least one computing device may also be configured to take into account at least one a vehicle-occupant-specific parameter when determining the first collision information. Vehicle-occupant-specific parameters may then enter in the determination of the first collision information, which would further increase its significance.

Vehicle-occupant-specific parameters may be, for example, the seat occupation of a vehicle occupant and/or the weight of a vehicle occupant and/or a model representative of the body shape of at least one vehicle occupant. It will be understood that the motor vehicle according to the invention includes suitable sensor systems which particularly monitor the passenger compartment of the vehicle, such as cameras, weight sensors, seat belt buckle sensors, and the like, which allow determination and optionally association of vehicle occupants in the passenger compartment as well as optionally their body measurements and weight.

According to an advantageous feature of the present invention, the at least one computing device may be configured for communication with at least one environmental monitoring device, in particular a vehicle sensor system, and may be further configured to take into account measurement data supplied by the environmental monitoring device when determining the first collision information. This may also improve the quality of the first collision information, i.e. the associated prognosis of an impending collision of the vehicle with a collision object. The environmental monitoring device, which is constructed in particular as a vehicle sensor system, may include, for example, radar sensors, ultrasound sensors, laser sensors, cameras, etc.

Advantageously, the comparison device may be configured to continuously or intermittently compare the first collision information with the second collision information and to output a corresponding individual comparison result for each comparison. Accordingly, the comparison device may optionally compare the first collision information and the second collision information several times and determine and output several corresponding comparison results, which may be advantageous for checking a first determined comparison result. Likewise, a comparison result may not only be formed and corresponding control information from the storage device be selected and used immediately at the start at the collision; instead, the selected control information may advantageously be adapted several times during the collision, for example when no airbag was triggered, but the collision course would suggest that this is still necessary because, for example, the collision course has changed.

The restraint system may be, for example, a seat belt tensioner and/or a seat belt force limiter and/or an airbag and/or a stiffness control of a passenger compartment and/or an adaptive head rest and/or a device for adjusting a seat position of a seat. This list of features is not comprehensive.

According to another aspect of the invention, a method for controlling at least one restraint system of a motor vehicle with at least one control device includes the steps of determining and outputting with at least one computing device at least one first collision information relating to an impending collision of the vehicle with a collision object before a collision of the vehicle with a collision object, determining and outputting with at least one computing device a second collision information relating to an actual collision of the vehicle with the collision object during the actual collision of the vehicle with the collision object, and comparing with a comparison device the at least one first collision information with the second collision information and outputting a comparison result. The method further includes the steps of selecting at least one control information stored in a storage device, when the comparison result indicates that the at least one first collision information is validated in relation to the second collision information, and controlling the at least one restraint system commensurate with the selected at least one control information, and selecting a standard control information of the at least one restraint system, when the comparison result indicates that the at least one first collision information is not validated in relation to the second collision information, and controlling the at least one restraint system commensurate with the standard control information.

The method according to the invention allows control of the at least restraint system commensurate with the specific situation in a collision of the vehicle with the collision object, which is particularly based on the comparison of the first collision information predicting an expected collision course and the second collision information representing the actual collision course, which can be described by the comparison result determined by the comparison device.

The comparison result may either indicate that the first collision information is validated or confirmed by the second collision information, i.e. that the collision course could be predicted with sufficient accuracy when the first collision information was determined, or that the first collision information cannot be validated or confirmed by the second collision information, i.e. that the collision course cannot be accurately enough predicted when the first collision information was determined.

In the first situation, i.e. with validation, a control information of the at least one restraint system which is situation-specific for the actual collision course, may be selected from the storage device and used to control the at least one restraint system. In the second situation, i.e. when validation is not possible, standard control information may be used and the at least one restraint system controlled accordingly. The standard control information is typically designed for a particularly severe collision.

As already mentioned with respect to the motor vehicle according to the invention, the comparison result between the first collision information and the second collision information, which can be easily determined and evaluated, may define within a very short time the strategy to be pursued for controlling the at least one restraint system. Complex and time-consuming computing processes or an adaptation of predefined control information to the actual collision course are thus not required within the context of the method of the invention.

According to an advantageous feature of the present invention, information which includes deformation information representing the expected a vehicle deceleration in an impending collision of the vehicle with a collision object and deformation information representing a measure for the expected degree of the deformation of the vehicle in the impending collision, may be used as the first collision information. In this context, the description relating to the first collision information of the motor vehicle according to the invention also applies to the method of the invention.

According to another advantageous feature of the present invention, information which includes the actual vehicle deceleration during the collision of the vehicle with the collision object and deformation information representing a measure for the actual degree of deformation of the vehicle during the collision may be used as second collision information. In this context, the description relating to the second collision information of the motor vehicle according to the invention also applies to the method of the invention.

According to another advantageous feature of the present invention, the control device of the at least one restraint system may preselect control information from the control device based on the first collision information. By preselecting situation-specific control information commensurate with the first collision information, the time until activation of the at least one restraint system can be further reduced, for example, due to a reduced computational complexity during the collision.

According to another advantageous feature of the present invention, the control device of the at least one restraint system may optionally select an alternative control information from the storage device based on the comparison result. For example, if the first collision information was validated by the comparison result, but a different control information may be better adapted to the situation in view of the actual collision course, the preselection is canceled and an alternative control information is selected and used.

According to yet another advantageous feature of the present invention, the control device may control the at least one restraint system with the standard control information in a collision of the vehicle with a collision object when the at least one computing device is unable to provide first collision information. Accordingly, in situations where first collision information cannot be determined and a comparison result can therefore also not be determined, or control information adapted to a situation cannot be selected from the storage device, the vehicle occupants continue to be protected, because the standard control information is resorted to in a collision.

In analogy to the description of the motor vehicle according to the invention, the at least one computing device may advantageously take into account at least one vehicle-specific parameter and/or collision-object-specific parameter when determining the first collision information. In this way, the quality of the prognosis for the impending collision and/or the significance of the first collision information may be enhanced.

With the same effect, the at least one computing device may advantageously take into account at least one a vehicle-occupant-specific parameter when determining the first collision information.

According to another advantageous feature of the present invention, the mass of the vehicle and/or the stiffness of the vehicle and/or the speed of the vehicle and/or the mass of the collision object and/or the stiffness of the collision object and/or the speed of the collision object and/or the relative speed between the vehicle and the collision object and/or the distance between the vehicle and the collision object and/or the distance between the vehicle and the collision object and/or acceleration and/or deceleration values of the vehicle and/or of the collision object may be used as the vehicle-specific and/or collision-object-specific parameter. This list is not comprehensive.

Advantageously, the seat occupation of a vehicle occupant and/or the weight of a vehicle occupant and/or a model representative of the body shape of at least one vehicle occupant may be used as the vehicle-occupant-specific parameter.

According to another advantageous feature of the present invention, the at least one computing device may communicate with at least one environmental detection device, in particular a vehicle sensor system, and may take into account measurement data provided by the environmental detection device when determining the first collision information. This information supplied by the environmental detection device also enhances the significance of the first collision information, in particular because the environmental detection device provides an exact image of the vehicle environment and possible collision objects located in that environment.

According to yet another advantageous feature of the present invention, the comparison device may continuously or intermittently compare the first collision information with the second collision information and output a corresponding individual comparison result for each comparison. By comparing the first collision information with the second collision information multiple times, the comparison result itself may advantageously be verifiable, i.e. different control information may be selected and used when the comparison result changes.

Otherwise, all discussions relating to the motor vehicle according to the invention apply also to the method according to the invention.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 shows a schematic diagram of a motor vehicle according to the present invention;

FIG. 2 shows a schematic block diagram showing the process flow of the method according to the present invention; and

FIGS. 3 and 4 show curves of vehicle decelerations with first and second collision information determined with the method according to the present invention.

### DETAILED DESCRIPTION OF PREFERRED EMBODIMENTS

Throughout all the figures, same or corresponding elements may generally be indicated by same reference numerals. These depicted embodiments are to be understood as illustrative of the invention and not as limiting in any way. It should also be understood that the figures are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

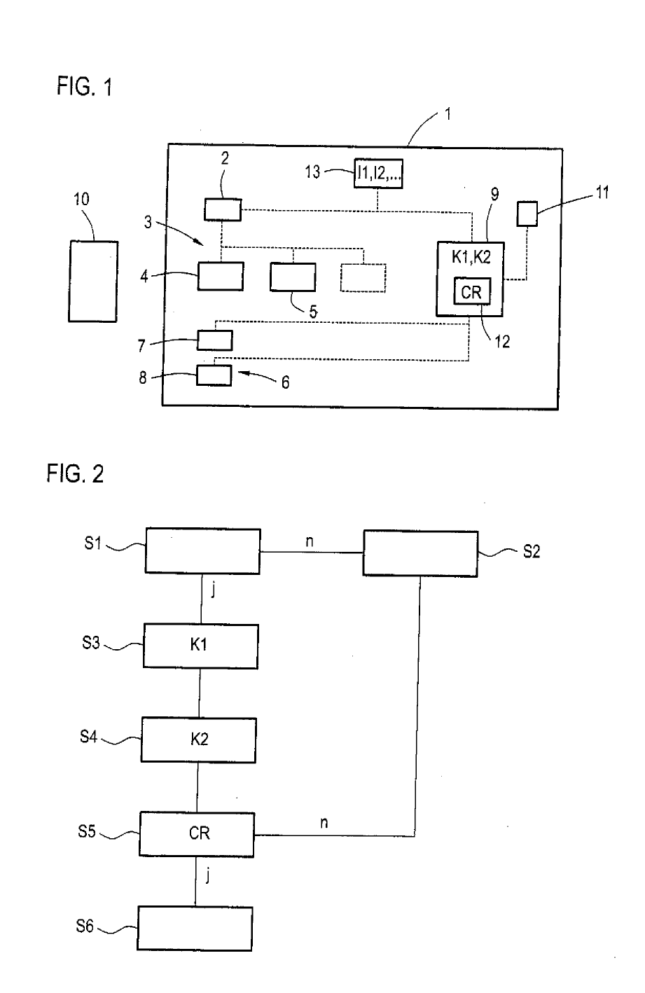

Turning now to the drawing, and in particular to FIG. 1, there is shown a schematic diagram of a motor vehicle 1 according to the invention. The motor vehicle 1 according to the invention may be powered by a conventional combustion engine, an electric motor or a hybrid drive; however, this is not important for the principle of the invention. The motor vehicle 1 includes several restraint systems 3 which can be controlled by a control device 2, wherein an airbag 4 and a belt tensioner 5 are shown as examples. It will be understood that additional restraint systems 3 may be present in the motor vehicle 1, such as adaptive head rest, systems for adjusting the seat position, additional airbags, etc., as indicated by the dashed box. All restraint systems 3 are connected with the control device 2 via corresponding communication lines configured as a network.

The motor vehicle 1 also includes an environmental detection device 6 which may include, for example, a radar sensor system 7 and a camera 8 for monitoring the environment of the vehicle.

In addition, a computing device 9 is provided. The computing device 9 is configured to determine an output at least one first collision information K1 relating to an impending collision of the motor vehicle 1 with the collision object 10, before the motor vehicle 1 collides with a collision object 10 located in the environment of the motor vehicle 1. In an actual collision of the motor vehicle 1 with collision object 10, the computing device 9 can during the collision determine and output second collision information K2 relating to the actual collision of the motor vehicle 1 with the collision object 10. For this purpose, at least one algorithm for determining the collision information K1, K2 is stored in the computing device 9.

The first collision information K1 includes, for example, the expected vehicle deceleration in form of one-dimensional or multi-dimensional vehicle deceleration curves in the impending collision of the vehicle 1 with a collision object 10 as well as deformation information representing a measure for the expected degree of the deformation of the vehicle 1 in the impending collision. The first collision information K1 therefore includes the expected collision course, data predicting the collision course, etc., and, whereas the second collision information K2 includes corresponding actual data for the collision process, the collision course, etc.

Because the computing device 9 communicates with the environmental detection device 6, i.e. the radar sensor system 7 and the camera 8 as well as the control device 2, measurement data provided by the environmental detection device 6 when the first collision information K1 was determined can be taken into account, which may provide for example information about the type of the collision object 10, allowing to distinguish if the collision object 10 is, for example, another vehicle, a person or a building.

The computing device 9 can, in addition to the environmental detection device 6, be connected with additional components of the motor vehicle 1, so that the computing device 9 can take into account different vehicle-specific and/or collision-object-specific parameters when determining the first collision information K1. These parameters include, for example, the mass of the vehicle 1 and/or the stiffness of the vehicle 1 and/or the speed of the vehicle 1. The mass of the collision object 10 and/or the stiffness of the collision object 10 and/or the speed of the collision object 10 can also be determined. Likewise, the relative speed between the vehicle 1 and the collision object 10 and/or the distance between the vehicle 1 and the collision object 10 and/or acceleration and/or deceleration values of the vehicle 1 and/or of the collision object 10 can be determined, so that overall different physical and/or mechanical and/or geometric parameters of the motor vehicle 1 and the collision object 10 can be considered when determining the first collision information K1, thus providing a very accurate assessment or prognosis about the impending collision, i.e. in particular its course or its severity.

In addition, advantageously additional vehicle-occupant-specific parameters are considered when the first collision information K1 is determined. These include, in particular, the seat occupation of a vehicle occupant and/or the weight of a vehicle occupant and/or a model representative of the body shape of at least one vehicle occupant. An estimate of the size, the seat position, the posture of the vehicle occupants may also be determined. For this purpose, different sensor arrangements 11 (not shown in detail), for example a camera monitoring the passenger compartment, seat belt lock sensors, etc. may be arranged inside the motor vehicle 1. The first collision information K1 may thus include also a representation of a deceleration of the vehicle occupants expected in the collision or vehicle-occupant-specific one-dimensional or multi-dimensional deceleration curves or estimates of expected injuries to the vehicle occupants.

The motor vehicle 1 according to the invention also includes a comparison device 12 forming, in particular, a part of the computing device 9, which is configured to compare the first collision information K1 with a second collision information K2 and to output a comparison result CR.

Furthermore, a storage device 13 is provided, in which control information I1, I2 etc. which is individually defined for different collision courses for controlling the restraint systems 3 are stored. The control information I1, I2 etc. is based in particular on model computations or simulations of different collision processes or collision courses while considering different vehicle-specific and/or object-specific parameters. As can be seen, the storage device 13 communicates with the computing device 9 and with the control device 2.

The method according to the invention for controlling at least one restraint system 3 that can be controlled by the control device 2 will now be described in more detail with reference to FIG. 2. According to step S1, it is checked when a collision object 10 is identified in the vicinity of the vehicle, if a first collision information K1 can be determined, for example, from the sensor data supplied by the environmental detection device 6 as well as from additional vehicle-specific and/or collision-object-specific data. It is thus checked if a prognosis relating to an impending collision of the motor vehicle 1 with a collision object is possible at all. At step S1, a functional test of the computing device 9, the comparison device 12 and additional components of the motor vehicle 1 required for carrying out the method according to the invention can be performed.

If a first collision information K1 cannot be determined, then a standard control information for controlling the restraint systems 3 is used in an actual collision of the motor vehicle 1 with the collision object 10, which controls the restraint systems 3 in a standard fashion.

If a first collision information K1 can principally be determined, then this collision information K1 is determined and outputted at step S3 by considering the aforementioned parameters. The control device 2 may already preselect control information I1, I2, etc which will be used in the actual collision depending on the first collision information K1.

At the following step S4, in an actual collision of the motor vehicle 1 with the collision object 10, a second collision information K2 is determined immediately at the start of the collision, and the first collision information K1 is compared with the second collision information K2 at the next step S5, and a comparison result CR is determined therefrom and outputted.

The comparison result CR which may be intermittently or continuously determined during the collision is a measure for the quality of the prognosis of the impending collision expressed by the first collision information K1. It can then be checked if the prognosis relating to the impending collision in form of their first collision information K1 is validated or confirmed by the second collision information K2 which relates to the actual collision course.

The computing device 9 may also determine more than one first collision information, if more than one possible collision process or more than one collision scenario is realistically possible in a specific situation of an impending collision. This may be the case when the type of the collision object 10 cannot be determined with sufficient accuracy. In this case, each first collision information K1 is separately compared with the second collision information K2 in a collision and a corresponding comparison result CR is outputted in each case. It will be understood that the most plausible first collision information K1, i.e. the comparison result CR with the strongest agreement between the first collision information and the second collision information, is used as basis for selecting control information adapted to a specific situation. However, the quantity or number of first collision information K1 may also be limited, so that the computing device may, for example, determine and output, respectively, at most three first collision information items.

Accordingly, a comparison result CR which indicates that the first collision information K1 is validated with respect to the second collision information K2, control information adapted to a specific situation, for example the control information I1, is selected from the storage device 13, at step 6, and the restraint systems 3 are controlled accordingly. If the collision with a collision object 10 is very slight, the control information I1 may, for example, stipulate not to trigger the airbag 4 and activate only the belt tensioner 5 with a corresponding actuator. If the selection of the exemplary control information I2 seems appropriate in view of the comparison result CR, because the severity of the collision exceeds a certain measure, then protection for the vehicle occupants can enhanced based on the control information I2 which contemplates triggering the airbag 4.

When control information I1, I2 has been selected within the context of the determination, the control device 2 can use the corresponding preselected control information I1, I2 to control the restraint systems 3 with this control information. If the preselection turns out to be unsuitable when the comparison result CR is determined, then the preselection can be discarded and alternative control information can be obtained from the storage device 13 and thereafter applied.

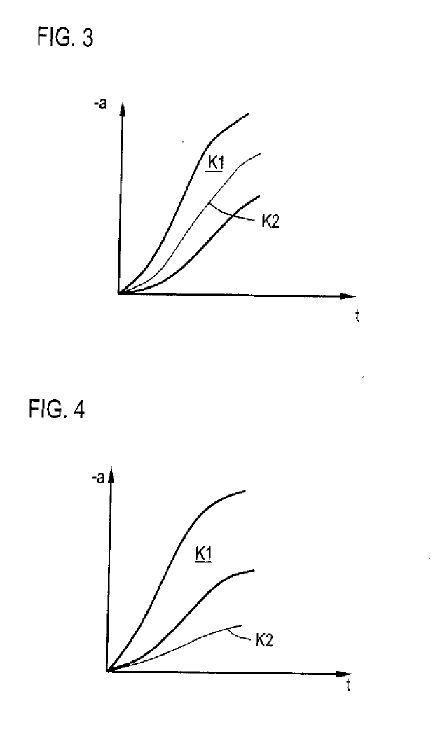

FIG. 3 illustrates an exemplary validation of the first collision information K1 by a second collision information K2, which shows a range of a vehicle acceleration predicted in the environment of the collision and an actual curve of a vehicle acceleration measured during the collision. Shown is the deceleration -a (y-axis) as a function of time t (x-axis). The range representing the first collision information K1, which forms a predicted corridor of one or several vehicle acceleration curves in the impending collision, is crossed by the line K2 representing the actual vehicle acceleration curve during the collision.

The control device 2 may also select alternative control information I1, I2 from the storage device based on the comparison result CR. The selected control information 11, 12 can thus be adjusted when the first collision information K1 is validated by the comparison result CR, which allows a more realistic control of the retaining systems 3 resembling the actual collision.

Conversely, if the comparison result CR indicates that the first collision information K1 cannot be validated with respect to the second collision information K2, then the standard control information of the restraint systems 3 is used to control the restraint system 3. Non-validation is shown as an example in the diagram of FIG. 4. Unlike in the diagram of FIG. 3, the line illustrating the second collision information K2 is located outside the region spanned by the first collision information K1.

The motor vehicle according to the invention and the method according to the invention, respectively, allow a particularly fast situation-specific control of the restraint systems 3, which furthermore is not very computational intensive and enhances protection for the vehicle occupants commensurate with the particular requirements.

While the invention has been illustrated and described in connection with currently preferred embodiments shown and described in detail, it is not intended to be limited to the details shown since various modifications and structural changes may be made without departing in any way from the spirit and scope of the present invention. The embodiments were chosen and described in order to explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

What is claimed is:

1. A motor vehicle, comprising:
at least one restraint system;
at least one control device controlling the at least one restraint system,
a storage device in communication with the at least one control device and storing control information for controlling the at least one restraint system, with the control information being individually defined for different collision processes,
at least one computing device, which is configured to determine and output, before a collision of the vehicle with a collision object, at least one first collision information relating to an impending collision of the vehicle with the collision object,
determine and output, during an actual collision of the vehicle with the collision object, second collision information relating to the actual collision of the vehicle with the collision object, and
a comparison device configured to compare the at least one first collision information with the second collision information and to output a comparison result,
wherein the control device is configured to select at least one control information stored in the storage device, when the comparison result indicates that the at least one first collision information is validated in relation to the second collision information, and to control the at least one restraint system commensurate with the selected at least one control information, and to select a standard control information of the at least one restraint system, when the comparison result indicates that the at least one first collision information is not validated in relation to the second collision information, and to control the at least one restraint system commensurate with the standard control information.

2. The motor vehicle of claim 1, wherein the control device is configured to preselect from the storage device a control information commensurate with the at least one first collision information.

3. The motor vehicle of claim 2, wherein the control device is configured to select from the storage device an alternative control information commensurate with the comparison result.

4. The motor vehicle of claim 1, wherein the control device is configured to control the at least one restraint system in a collision commensurate with the standard control information, when the at least one computing device is unable to output the at least one first collision information.

5. The motor vehicle of claim 1, wherein the at least one first collision information comprises information selected from an expected vehicle deceleration in the impending collision and deformation information indicating a measure for an expected degree of deformation of the vehicle in the impending collision.

6. The motor vehicle of claim 1, wherein the second collision information comprises information selected from an actual vehicle deceleration in the collision and deformation information indicating a measure for an actual degree of deformation of the vehicle in the impending collision.

7. The motor vehicle of claim 1, wherein the at least one computing device is configured to take into account at least one of a vehicle-specific parameter and a collision-object-specific parameter when determining the at least one first collision information.

8. The motor vehicle of claim 1, wherein the vehicle-specific parameter and the collision-object-specific parameter is a parameter selected from a mass of the vehicle, a stiffness of the vehicle, a speed of the vehicle, a mass of the collision object, a stiffness of the collision object, a speed of the collision object, a relative speed between the vehicle and the collision object, a distance between the vehicle and the collision object, acceleration and/or deceleration values of the vehicle, and acceleration and/or deceleration values the collision object.

9. The motor vehicle of claim 1, wherein the at least one computing device is configured to take into account at least one vehicle-occupant-specific parameter when determining the at least one first collision information.

10. The motor vehicle of claim 1, wherein the at least one vehicle-occupant-specific parameter is a parameter selected from a seat occupation of a vehicle occupant, a weight of the vehicle occupant, and a model representative of a body shape of at least one vehicle occupant.

11. The motor vehicle of claim 1, wherein the at least one computing device is configured to communicate with at least one environmental detection device and to take into account measurement data provided by the environmental detection device when determining the at least one first collision information.

12. The motor vehicle of claim 11, wherein the at least one environmental detection device comprises a vehicle sensor system.

13. The motor vehicle of claim 1, wherein the comparison device is configured to continuously or intermittently compare the at least one first collision information with the second collision information and to output a corresponding individual comparison result for each comparison.

14. The motor vehicle of claim 1, wherein the restraint system comprises at least one of a seat belt tensioner, a seat belt force limiter, an airbag, a stiffness control of a passenger compartment, an adaptive head rest, and a device for adjusting a seat position of a seat.

15. A method for controlling at least one restraint system of a motor vehicle with at least one control device, comprising the steps of:
before a collision of the vehicle with a collision object, determining and outputting with at least one computing device at least one first collision information relating to an impending collision of the vehicle with a collision object,
during the collision of the vehicle with the collision object, determining and outputting with at least one computing device a second collision information relating to an actual collision of the vehicle with the collision object, and
comparing with a comparison device the at least one first collision information with the second collision information and outputting a comparison result,
selecting at least one control information stored in a storage device, when the comparison result indicates that the at least one first collision information is validated in relation to the second collision information, and controlling the at least one restraint system commensurate with the selected at least one control information, and
selecting a standard control information of the at least one restraint system, when the comparison result indicates that the at least one first collision information is not validated in relation to the second collision information, and controlling the at least one restraint system commensurate with the standard control information.

16. The method of claim 15, and further preselecting with the at least one control device from the storage device a control information commensurate with the at least one first collision information.

17. The method of claim 16, and further selecting with the at least one control device an alternative control information from the storage device commensurate with the comparison result.

18. The method of claim 15, and further controlling the at least one restraint system in a collision commensurate with the standard control information, when the at least one computing device is unable to output the at least one first collision information.

19. The method of claim 15, wherein the at least one first collision information comprises information selected from an expected vehicle deceleration in the impending collision and deformation information indicating a measure for an expected degree of deformation of the vehicle in the impending collision.

20. The method of claim 15, wherein the second collision information comprises information selected from an actual vehicle deceleration in the collision and deformation information indicating a measure for an actual degree of deformation of the vehicle in the impending collision.

21. The method of claim 15, wherein the at least one computing device takes into account at least one of a vehicle-specific parameter and a collision-object-specific parameter when determining the at least one first collision information.

22. The method of claim 21, wherein the vehicle-specific parameter and the collision-object-specific parameter is a parameter selected from a mass of the vehicle, a stiffness of the vehicle, a speed of the vehicle, a mass of the collision object, a stiffness of the collision object, a speed of the collision object, a relative speed between the vehicle and the collision object, a distance between the vehicle and the collision object, acceleration and/or deceleration values of the vehicle, and acceleration and/or deceleration values the collision object.

23. The method of claim 15, wherein the at least one computing device takes into account at least one vehicle-occupant-specific parameter when determining the at least one first collision information.

24. The method of claim 23, wherein the at least one vehicle-occupant-specific parameter is a parameter selected from a seat occupation of a vehicle occupant, a weight of the vehicle occupant, and a model representative of a body shape of at least one vehicle occupant.

25. The method of claim 15, wherein the at least one computing device communicates with at least one environmental detection device and takes into account measurement data provided by the environmental detection device when determining the at least one first collision information.

26. The method of claim 15, wherein the comparison device continuously or intermittently compares the at least one first collision information with the second collision information and outputs a corresponding individual comparison result for each comparison.

27. The method of claim 25, wherein the at least one environmental detection device comprises a vehicle sensor system.
